(19) United States
(12) Patent Application Publication
(10) Pub. No.: US 2013/0226716 A1
(43) Pub. Date: Aug. 29, 2013

(54) System and Method for Determining Time and Sequence in Meal Preparation

(71) Applicant: Be Labs, LLC, (US)

(72) Inventor: Edward Balassanian, Seattle, WA (US)

(73) Assignee: Be Labs, LLC, Seattle, WA (US)

(21) Appl. No.: 13/710,368

(22) Filed: Dec. 10, 2012

Related U.S. Application Data
(60) Provisional application No. 61/568,480, filed on Dec. 8, 2011.

(51) Int. Cl. G06Q 30/00; G06Q 50/12

(52) U.S. Cl. CPC G06Q 30/00; G06Q 50/12
USPC 705/15

(57) ABSTRACT

Disclosed is a system and method for managing ingredients and recipes while providing an interface for consumers to request a meal based on one or more recipes. Additionally, preparation and production steps are defined based on the ingredients of one or more recipes. The time for preparation and production is also calculated and presented.

### RELATED APPLICATIONS

This patent claims priority to and the benefit of U.S. Provisional Application No. 61/568,480, filed on Dec. 8, 2011, and entitled “System and Method for Determining Time and Sequence in Meal Preparation.”

### SUMMARY OF THE INVENTION WITH BACKGROUND INFORMATION

Online ordering services may enable customers to specify one or more meals and drinks for delivery or pickup. Further, online ordering services may provide an option for customers to customize their meals. For example, a pizza restaurant may provide its customers with a website configured to allow customers to select the size of a pizza, choose tram either predetermined toppings or customize by selecting the specific toppings, and provide information regarding pick-up or delivery.

Inventory systems are used by restaurant operators to track the quantity of ingredients currently owned for use in one or more meals. Further, inventory systems can be configured to notify an operator when it is time to order more of one or more specific ingredients.

Moreover, prior art does not provide solutions for use within the raw food industry. Often ingredients used in a first recipe produce residuals that can be used in a second recipe. As used herein, a “residual” is a leftover material from a first recipe that can be used in at least one other recipe. The prior art fails to track residuals, nor does the prior art associate residuals with one or more recipes.

Further, prior art does not provide a system to determine the sequence and estimated time to prepare one or more recipes based on one or more ingredients.

Even further, prior art does not provide a system for factoring supply availability into a real-time order processing system.

A solution that automatically determines the steps and time to produce a recipe has eluded those skilled in the art, until now.

A solution that determines the appropriate sequence for producing one or more recipes for a given meal has eluded those skilled in the art, until now.

A solution that determines the real-time availability of supplies to produce one or more recipes has eluded those skilled in the art, until now.

It would be advantageous to provide a system that automatically determines the appropriate timing to prepare ingredients needed for recipes based on customer demand for a given meal, and further determines the supply required for each ingredient.

It would be further advantageous to provide a system that automatically determines the time and steps needed for preparing one or more ingredients for one or more recipes based on one or more meal requests, and that further factors in supply time.

The present inventive system and method relates to a service provided on a computer network. The service may provide users with meal ordering, tracking and nutritional management. For example and without limitation, there may be one or more web pages for ordering, tracking meals, and managing nutrition. In one embodiment, the service permits one or more individuals order one or more meals online for pickup or delivery, to track the meals they have consumed and to manage their nutrition.

One or more individuals (or entities, groups, or any other potential users of the service) may access the system. Such parties are referred to herein as “users”. A user may also be an administrator for the system. An administrator may be authorized to access the meal management system to input recipes, manage supplies or edit pricing.

The raw food industry specializes in meals and drinks that are solely from organic vegetables and fruits. Raw Meals and drinks are not cooked and cannot be warmed over 118 degrees, otherwise the nutrient levels are significantly reduced. Further, meals and drinks can be prepared with specialized equipment designed to ensure maximum nutrient retention during preparation. For example, the Norwalk Juicer presses fruits and vegetables to extract the juice.

As used herein, a “recipe” comprises one or more ingredients used to produce food or drink for consumption. The term “meal” refers to any food or drink prepared for consumption.

As used herein, an “attribute” is data relating to a meal, ingredient, or recipe. Without limitation, an attribute may be the nutritional value of a recipe (calories, protein, vitamin A, etc . . . ), wellness values (digestion, weigh management, etc . . . ), texture (hard, soft, creamy, etc.), allergy information, one or mere residuals associated with a particular ingredient or recipe, or other related information, with the following two exceptions.

As used herein, “time attribute” (which is discussed in greater detail below) refers to the amount of time needed to prepare an ingredient or a recipe, depending on context. “Production attribute” refers to specific information related a recipe, specifically, the process to produce a recipe using one or more ingredients. The term “attribute” as used herein excludes “time attributes” and “production attributes”, which are discussed as separate terms unless otherwise indicated.

### BRIEF DESCRIPTION OF THE DRAWINGS

An understanding of the present disclosed system and method may be obtained by reference to the accompanying drawings, when considered in conjunction with the subsequent, detailed description, in which:

FIG. 1 is an illustration of one embodiment of the system and its components;

FIG. 2 is an illustration of one embodiment of data base model for storing a recipe comprising one or more ingredients, each of the one or more ingredients having one or more associated attributes;

FIG. 3 is a flow chart detailing one embodiment of a process for facilitating one or more meal requests by a user.

### DETAILED DESCRIPTION

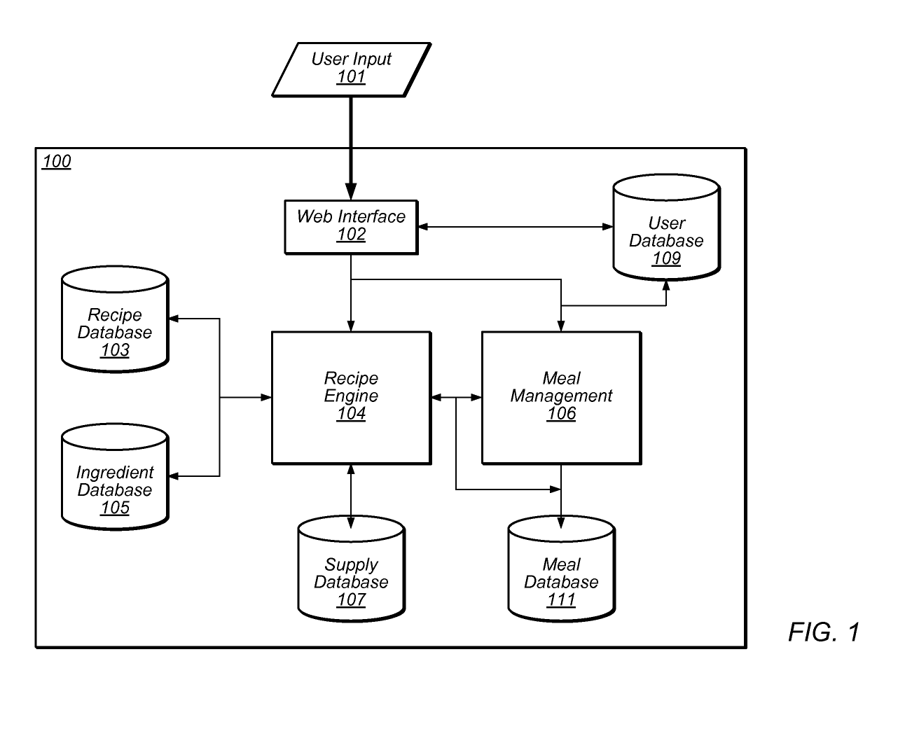

FIG. 1 is an illustration of the components that comprise one embodiment of the system described in detail below. Unless indicated otherwise, all functions described herein may be performed in either hardware, software, firmware, or some combination thereof In some embodiments the functions may be performed by a processor, such as a computer or an electronic data processor, in accordance with code, such as computer program code, software, and/or integrated circuits that are coded to perform such functions. Those skilled in the art will recognize that software, including computer-executable instructions, for implementing the functionalities of the present invention may be stored on a variety of computer readable media including hard drives, compact disks, digital video disks, computer servers, integrated memory storage devices and the like.

Any combination of data storage devices, including without limitation computer servers, using any combination of programming languages and operating systems that support network connections, is contemplated for use in the present inventive method and system. The inventive method and system are also contemplated for use with any communication network, and with any method or technology, which may be used to communicate with said network. It is contemplated that the present inventive system and method may be used in connection with recipes involving cooked food as well as raw food.

In one embodiment, the system 100 includes a web interface module 102 configured to receive input from multiple types of input sources 101 and display one or more web pages. For example, the input source can be a browser executing on a personal computer or a mobile device.

In the illustrated embodiment, the components of system 100 are resident on a computer server; however, those components may be located on one or more computer servers, one or more user devices (such as one or more smart phones, laptops, tablet computers, and the like), any other hardware, software, and/or firmware, or any combination thereof The system includes databases to store recipe data 103, ingredient data 105 and supply data 107. The user database 109 stores information relating to one or more users. Without limitation, a user can be any one of a customer, a cook, a nutritionist or an administrator. The recipe engine component 104 provides the intelligence for mapping ingredients and their attributes to recipes and their specific health attributes. The recipe engine may also maintain an administrative interface to add, delete and modify the stored recipes and the associated ingredients.

In the illustrated embodiment, the meal management component 106 handles meal requests based on either a request from a user or directly from within the system itself (for example, a chef or nutritionist). Additionally, the meal management component is configurable to provide recommendations. For example, recommendations can be based on nutritional requirements or based on health goals of a specific user. The meal management component can be configured to communicate directly with the recipe engine to map the attributes of recipes to the user's health goals.

In a further embodiment, a user input can be one or more of the following: nutritional goals, wellness goals, or a QR code from a user that relates to one or more consumed meals.

The meal database 111 stores information relating to users' completed meals based on one or more recipes.

In an alternative embodiment the meal database and recipe database are the same. In a further alternative embodiment the meal management component and recipe engine are the same component.

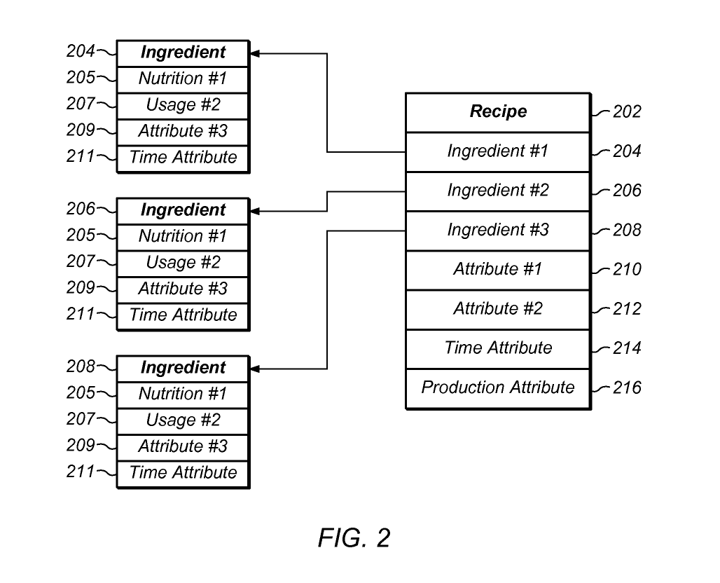

FIG. 2 is an illustration of one embodiment of a database model for storing a recipe comprising one or more ingredients, each of the one or more ingredients having one or more associated attributes. A recipe 202 is comprised of one or more ingredients. For purposes of illustration the recipe in this embodiment contains three ingredients 204, 206, and 208 respectively.

In a preferred embodiment, information is stored in association with an ingredient. In the illustrated embodiment, each ingredient in a recipe has nutritional information 205, usage information 207 and attributes 209. Nutritional information may be any one of calories, protein, vitamin A, or any other nutritional related information. Usage information indicates how the ingredient can be used in one or more recipes. For example, usage information for ingredient ‘x’ may indicate that ingredient ‘x’ can be used by being blended or pressed in a juice recipe, sliced for a salad recipe, or chopped for a salsa recipe. Further, ingredients may have various preparation and production characteristics depending on the recipe. For example, beans or nuts might need to be soaked, or beans might need to sprout before they are used in a given recipe. Additionally, the shelf life of an ingredient may be stored. Information related to any and all uses may be stored in these related fields.

Further, an ingredient can have one or more associated time attributes 211. The time attributes associated with an ingredient represent the known time needed to prepare the ingredient for a recipe based on one or more usages. A user or administrator who has previously prepared an ingredient based on a specific usage can provide the time attribute for that particular ingredient and usage. Each ingredient can have one or more time attributes associated with it, each particular time attribute being associated with a particular item of usage information 207.

For example, the usage information 207 “almond milk”, in association with the ingredient 204 “almonds”, may have a time attribute 211 of “20 hours”, representing 20 hours of soaking time required before almonds may be blended into almond milk. There could further be a second time attribute associated with the usage information of “almond milk” representing a production time that relates to the known time to drain and blend the soaked almonds for a given volume of milk. Time attributes can be associated with both preparation and production times for a given ingredient based on its use within one or more recipes. As used herein, “preparation” refers to the activities that are necessary or desirable for preparing an ingredient for use in a recipe. “Production” refers to all other activities, aside from preparation, that are necessary or desirable for producing a particular meal associated with a recipe.

As discussed above, attributes can include wellness values, texture, ingredient and/or recipe residuals, preparation steps, or other recipe related information. For simplicity of illustration, only one attribute is related to each ingredient in FIG. 2. However, it is understood there are no limitations with regards to the amount of nutritional information (for example, the number of data elements associated with nutrition), usage information, attributes, time attributes, and production attributes the system can be configured to store in association with each ingredient, meal, and/or recipe. Further, the system is configurable to store any type of data associated with an ingredient, meal, and/or recipe. Even further, the system is configurable to store any data or no data related to one or more ingredients, meals, and/or recipes.

In a preferred embodiment, a recipe includes one or more attributes. Without limitation, attributes can be any one of data relating to nutritional value of the recipe (calories, protein, vitamin A, etc.), wellness values (digestion, weight management, etc.), texture (hard, soft, creamy, etc.), allergy information, ingredient and recipe production residuals or other recipe related information.

Further, a recipe can have one or more associated time attributes 214. The time attribute for a particular recipe may represent the sum of the total preparation time calculated based on the usage at each ingredient within that recipe. This may be the sum total of all preparation times for the ingredients in that recipe. Alternatively, if the ingredients are prepared at the same time, the time attribute may be equal to the longest preparation time associated with an ingredient in that receipt. A user or administrator who has previously prepared a recipe can provide the time attribute.

Further, time attributes can relate to the production time for a recipe. There may be a separate time attribute for preparation time, as well as a separate time attribute that relates to production time required based on one or more process steps after the ingredients are combined. For example, a chocolate tart may take 30 minutes based on preparation times associated with each ingredient. However, the tart may require 24 hours of refrigeration once prepared. This additional time attribute may be stored. Further, time attributes that relate to production may be associated directly with one or more production attributes 216.

Without limitation each production attribute 216 may include specific information related to the recipe, specifically, the process to produce a recipe using one or more ingredients. A recipe can have any number of production attributes associated with it. Production attributes can have a specific sequence that relates to the order in which each production attribute should be considered and executed. Production attributes can be directly related to one or more ingredients, attributes, time attributes, or other information stored in association with a recipe.

For simplicity of illustration only three ingredients and two recipes attribute values, 210 and 212, one time attribute 214, and one production attribute 216 are shown with the recipe in FIG. 2, however, it is understood there are no limitations with regards to the number of ingredient, attributes, time attributes, or production attributes the system can be configured to store associated with each recipe.

Further, the system is configurable to store any type of data associated with a recipe. Even further, the system is configurable to store any data or no data related to one or more recipes.

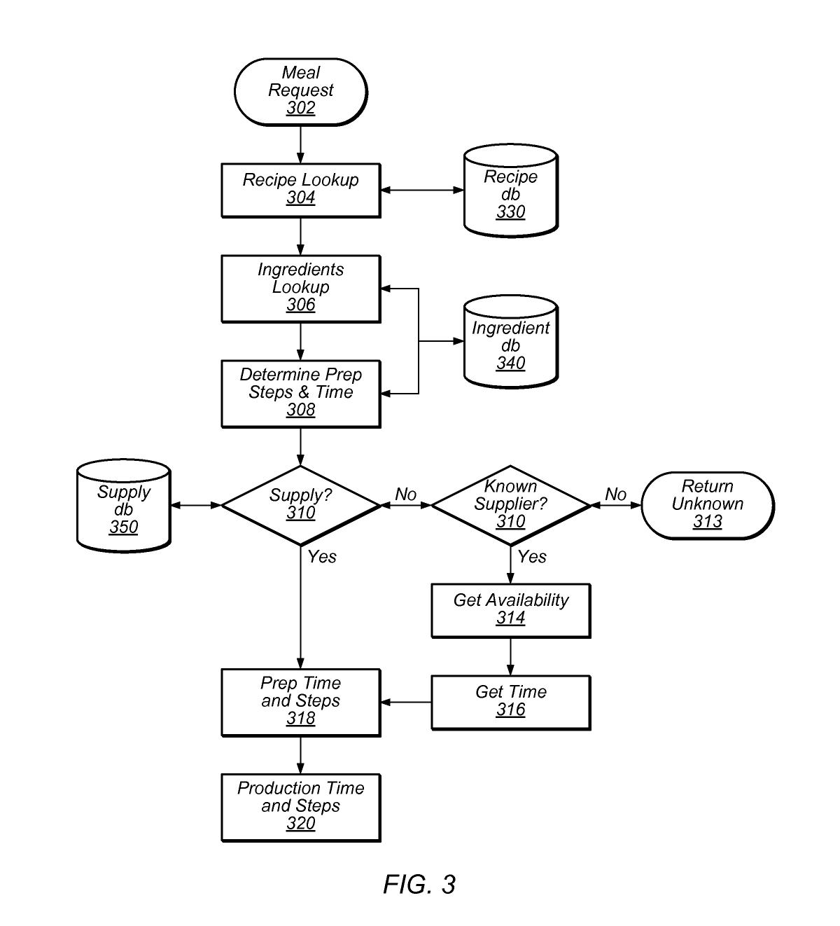

FIG. 3 is a flow chart detailing one embodiment of a process for determining the time and steps needed to create one or more meals based on one or more recipes. The process begins when a meal request is received 302 from one or more sources. As previously described a meal can be any one of food or drink or any combination of multiple food and drink combinations. Next, based on the meal request, the one or more required recipes 304 are retrieved from the recipe database 330. Next, based on the one or more recipes determined in step 304, one or more ingredients 306 are retrieved from the ingredient database 304. Next, the process examines associated attributes for each ingredient to determine the preparation steps for a given use and time required 308. As described in detail above, ingredients can have any number of attributes, time attributes, and/or items of usage information and/or nutritional information. Next, the process checks for available supply 310 from the supply database 350. Supplies can be any one of, but not limited to, ingredients, production equipment required, storage availability, personnel, or containers for consumption.

In the case where the one or more required supplies are available the process continues with step 318, as discussed below.

In the case where the required supply is not available, the process determines if there are known suppliers for the one or more required supplies 312. In the case where there is no known supplier, the system returns “unknown” at step 313. If there is a known supplier, the process checks availability for the required supply 314. Next, based on availability the system determines the time for supplier to provide supplies to be used with the meal request 316. The system operates can be configured to communicate with suppliers in real-time.

Next, the process determines the time and steps for preparation 318. As described in detail above, usage information and time attributes can be associated with an ingredient used within a recipe. One or more lists may be prepared containing a sequence of preparation steps and an estimated time for completion. This calculation can take into account supply timing if a required supply is currently not available.

In a further embodiment, the list can be provided to one or more users to execute. For example, the list could be provided to a prep chef

Next, the process determines the time and steps for production 320. Production time and steps calculated may relate to any number of recipes required to complete the meal request. One or more lists may be prepared containing a sequence of production steps and an estimated time for completion.

In a further embodiment, the list can be provided to one or more users to execute. For example, the list could be provided to a chef

In an alternative embodiment the process for calculating time, preparation steps and production steps can be combined in a single step.

In a further embodiment the production calculation in step 320 can determine the sequence of preparation and production for two or more meals so that residuals created by one recipe can be used in another. Further, the production calculation of two or more meals can determine the appropriate production sequence based on available supply or the shelf life of existing ingredients.

In an alternative embodiment the supply can be determined before individual steps and time are calculated for each ingredient.

In a further alternative embodiment, there is no supply verification step.

In a further embodiment the process can be extended to notify the user or administrator about timing, supply issues and/or alternatives. For example, if a specific ingredient is unavailable for a specific period of time, the system can recommend one or more alternative ingredients. Further, the system can recommend one or more alternative recipes. Even further the system can verify that the recommended alternative ingredients or alternative recipes contain similar or equivalent health attributes to that of the requested meal.

Thus, in summary, it can be seen that what is described in this disclosure is a system for managing one or more ingredients, recipes and meals. Further, the system may enable one or more users to make one or more meal requests. Based on the one or more meal requests the system can determine the steps, estimated time and supply requirements to satisfy each meal request.

Since other modifications and changes varied to fit particular operating requirements and environments will be apparent to those skilled in the art, the invention is not considered limited to the example chosen for purpose of disclosure, and covers all changes and modifications which do not constitute departures from the true spirit and scope of the invention.

1. A method of preparing a meal, comprising:
providing an online service, the online service enabling creation of accounts, each account being configured to enable tracking of nutritional information;
receiving a request to prepare a meal, the request being associated with an account;
retrieving at least one recipe associated with the meal;
retrieving a plurality of ingredients associated with the meal and a plurality of steps for preparing the meal;
determining preparation steps and time;
providing preparation information related to the ingredients and the plurality of steps for preparing the meal; and
storing nutritional information for the meal in association with the account for later retrieval.
